(19) United States
(12) Patent Application Publication
(10) Pub. No.: US 2013/0110491 A1
(43) Pub. Date: May 2, 2013

(54) DISCRIMINATIVE LEARNING OF FEATURE FUNCTIONS OF GENERATIVE TYPE IN SPEECH TRANSLATION

(71) Applicants: Xiaodong He, Issaquah, WA (US); Li Deng, Redmond, WA (US)

(72) Inventors: Xiaodong He, Issaquah, WA (US); Li Deng, Redmond, WA (US)

(73) Assignee: MICROSOFT CORPORATION, Redmond, WA (US)

(21) Appl. No.: 13/283,633

(22) Filed: Oct. 28, 2011

(51) Int. Cl. G06F 17/28

(52) U.S. Cl. 704/2

(57) ABSTRACT

Architecture that formulates speech translation as a unified log-linear model with a plurality of feature functions, some of which are derived from generative models. The architecture employs discriminative training for the generative features based on an optimization technique referred to as growth transformation. A discriminative training objective function is formulated for speech translation as well as a growth transformation-based model training method that includes an iterative training formula. This architecture is used to design and perform the global end-to-end optimization of speech translation, which when compared with conventional methods for speech translation provides not only a learning method with faster convergence but also improves speech translation accuracy.

### BACKGROUND

The speech translation problem can be formulated as a log-linear model with multiple features that capture different levels of dependency between the input voice observation and the output translations. However, while the log-linear model itself is of a discriminative nature, where many of the feature functions (e.g., scores of automatic speech recognition outputs) are derived from generative models. Moreover, these features are usually trained (estimated) by conventional maximum likelihood estimation.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture formulates speech translation as a unified log-linear model with a plurality of feature functions, some of which are derived from generative models. The architecture employs discriminative training for the generative features based on an optimization technique referred to as growth transformation. A discriminative training objective function is formulated for speech translation as well as a growth transformation-based model training method that includes an iterative training formula. This architecture is used to design and perform the global end-to-end optimization of speech translation not only a learning method with faster convergence but also improves speech translation accuracy.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates a method in accordance with the disclosed architecture.

FIG. 3 illustrates further aspects of the method of FIG. 2.

FIG. 4 illustrates an alternative method in accordance with the disclosed architecture.

FIG. 5 illustrates further aspects of the method of FIG. 4.

FIG. 6 illustrates a block diagram of a computing system that executes translation according to a unified translation system in accordance with the disclosed architecture.

### DETAILED DESCRIPTION

The disclosed architecture is a general framework of discriminative training for generative feature functions based on a technique referred to herein as growth transformation (GT). A discriminative training objective function is developed for a unified speech translation (ST) model and growth transformation training is disclosed.

Speech translation takes the source speech signal as input and produces as output the translated text of that utterance in another language. In a general architecture for ST, using a foreign language F spoken and English E as the translated output, for example, as an input speech signal X is first fed into a speech recognizer component (e.g., automatic speech recognition (ASR)), and the recognizer component generates a recognition output hypothesis set {F}, which is in the source (or foreign F) language. Letter F represents a recognition hypothesis in an N-best list (while in practice, a lattice is usually used as a compact representation). The recognition hypothesis set {F} is finally passed to a machine translation (MT) component convert text (or speech, using speech synthesis) of a source language into a translated version of the target language (e.g., translation sentence E (in English)).

Comparing the ASR process and the MT process, there is a strong similarity between the processes, with only one major difference that MT includes a non-monotonic decoding process while the order of the output symbols of ASR is monotonic to the order of the input symbols. The HMM (hidden Markov model)-based acoustic model in ASR and the phrase based translation model in MT with fixed reordering have essentially the same mathematical form. This similarity makes it possible to extend the unified discriminative training approach developed for ASR to discriminative MT training.

Conventionally, and with very few exceptions, ASR, translation, and language models are trained separately and are optimized by different criteria. As described herein, the GT-based general discriminative training framework is extended to train all the model parameters jointly so as to optimize the end-to-end ST quality.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

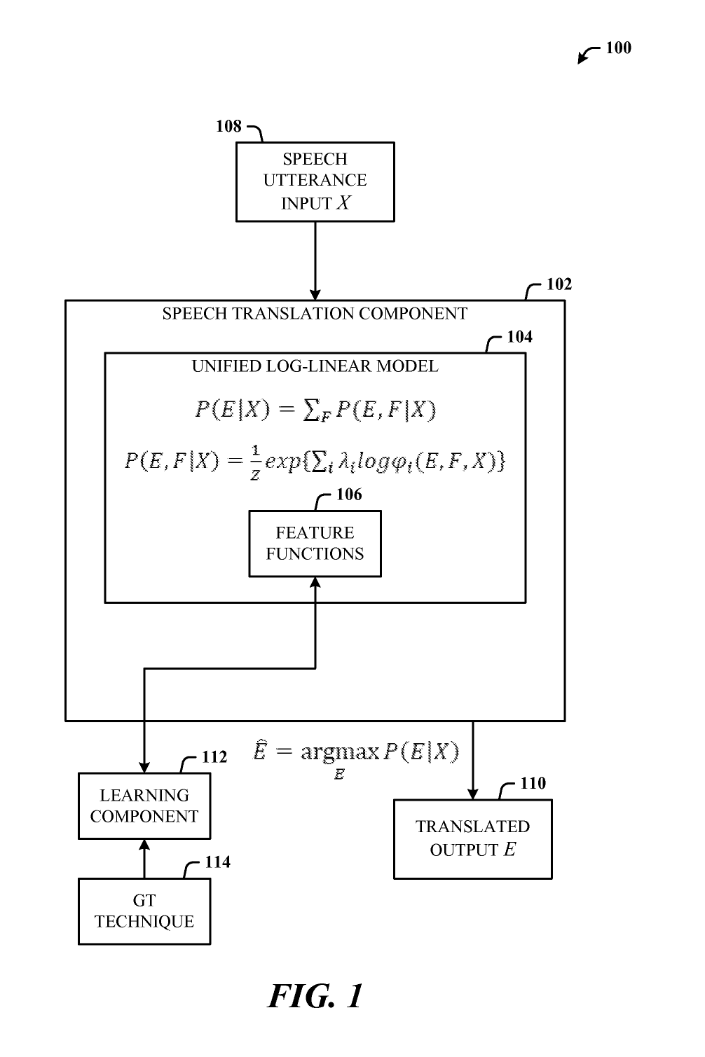

FIG. 1 illustrates a system 100 in accordance with the disclosed architecture. The system 100 includes a speech translation component 102 formulated as a unified log-linear model 104 of recognition and translation. The unified log-linear model 104 includes multiple generative feature functions 106 for dependency evaluation between input speech recognition (of speech utterance X 108) and corresponding output translations (translated output E 110). The system 100 can also employ a learning component 112 that performs discriminative training of the generative feature functions 106 in a speech translation system using a growth transformation technique 114 to fix free parameters in the entirety of the speech translation system based on training data.

The learning component 112 trains the conventional feature functions of generative type discriminatively (of the feature functions 106). The learning component 112 performs discriminative training on recognition model parameters and translation model parameters jointly in a unified log-linear speech translation model of both recognition and translation. The learning component 112 employs a discriminative training objective function and optimizes the multiple generative feature functions as part the training. The objective function for the unified log-linear model considers an input speech signal, a recognition hypothesis, and a translated output. In a more specific implementation, the objective function considers minimum sentence translation error rate, minimum translation edit rate, maximum average sentence BLEU (bi-lingual evaluation understudy) score, maximum corpus BLEU score, and/or maximum conditional likelihood. The unified log-linear model 104 includes feature weights that are trained to maximize a translation quality score of a final translation of a validation input set. The objective function is a model-based expectation of a classification quality measure. The growth transformation technique 114 employs a primary auxiliary function that considers a model to be estimated, and a model obtained from an immediately previous iteration. The discriminative training can be performed across multiple machine translators.

Following is a description of the formulation of the objective function and the use of growth transformation of the generative feature functions.

With respect to a unified log-linear model representation for ST, the optimal translation Ê given the input speech signal X is obtained via the decoding process according to,

$$\hat{E} = {arg max }_{E} P ( E \vert X )$$

Based on a law of total probability,

$$P ( E \vert X ) = {\sum }_{F}^{ } P ( E , F \vert X )$$

The posterior probability of the (E, F) sentence pair given X through a log-linear model can be modeled as the following:

$$P ( E , F \vert X ) = \frac{1}{Z} exp \{ {\sum }_{i}^{ } {λ}_{i} log {ϕ}_{i} ( E , F , X ) \} ,$$

where

$$Z = {\sum }_{E , F}^{ } exp \{ {\sum }_{i}^{ } {λ}_{i} log {ϕ}_{i} ( E , F , X ) \}$$

is the normalization denominator to ensure that the probabilities sum to one.

Following is a description of the discriminative training objective function. Denote X=X₁ . . . X_{R} as the superstring of concatenating all R training utterances, and E=E₁ . . . E_{R} as the superstring of concatenating all R training references; the objective function can then be defined as:

$$O ( Λ ) = {\sum }_{E}^{ } p ( E \vert X , Λ ) \cdot {C}_{DT} ( E )$$

The objective function can cover a number of metrics, including, but not limited to, minimum sentence error rate Σᵣ{δ(Eᵣ, Eᵣ*)}, minimum translation edit rate (TER) Σᵣ{|Eᵣ*|x[1−TER(Eᵣ, Eᵣ*)]}, maximum average sentence BLEU Σᵣ {BLEU(Eᵣ, Eᵣ*)}, maximum corpus BLEU BLEU(E, E*), and maximum conditional likelihood Πᵣ {δ(Eᵣ, Eᵣ*)}, for example.

This is the model-based expectation of the classification quality measure C_{DT}(E) for ST, where C_{DT}(E) is the evaluation metric, or its approximation. For translation, the quality can be evaluated using bi-lingual evaluation understudy (BLEU) scores or translation edit rate (TER). One example of C_{DT}(E) for ST employed herein is the following:

C_{DT}(E)=ΣᵣBLEU(Eᵣ,Eᵣ*),

which is proportional (by 1/R) to the average of sentence level BLEU scores.

With respect to growth transformation for model training, it follows from the above computations that:

$$p ( E \vert X , Λ ) = \frac{{Σ}_{F} {Π}_{i} {ϕ}_{i}^{{λ}_{i}} ( E , F , X \vert Λ )}{{Σ}_{E} {Σ}_{F} {Π}_{i} {ϕ}_{i}^{{λ}_{i}} ( E , F , X \vert Λ )}$$

$$and , \\ O ( Λ ) = \frac{{Σ}_{E} {Σ}_{F} {Π}_{i} {ϕ}_{i}^{{λ}_{i}} ( E , F , X \vert Λ ) {C}_{DT} ( E )}{{Σ}_{E} {Σ}_{F} {Π}_{i} {ϕ}_{i}^{{λ}_{i}} ( E , F , X \vert Λ )}$$

where φᵢ(E, F, X|Λ)=Πᵣ₌₁^{R}φᵢ^{α}^{ᵢ} (Eᵣ, Fᵣ, Xᵣ|Λ) represent the i-th feature described above.

Similarly,

C_{DT}(E)=ΣᵣC_{DT}(Eᵣ)

where C_{DT}(Eᵣ)=BLEU(Eᵣ, Eᵣ*) is the BLEU score of the r-th sentence. (Hereinafter, the subscript C_{DT}(E) is omitted for simplification.)

Using the super-string annotation, the primary auxiliary function can be constructed as the following:

F(Λ;Λ′)=Σ_{E}Σ_{F}Πᵢφᵢ^{λ}^{ᵢ}(X,E,F|Λ)[C(E)−O(Λ′)]

where Λ denotes the model to be estimated, and Λ′, the model obtained from the immediately previous iteration.

Following is a set of feature functions constructed and employed in a speech translation system (derived from both the speech recognition and machine translation modules):

Acoustic model (AM) feature:

φ_{AM}(E, F, X)=p(X|F), which is the likelihood of speech signal X given a recognition hypothesis F, computed from the AM of the source language. This is usually modeled by a hidden Markov model (HMM).

Source language model (LM) feature:

φ_{SLM}(E, F, X)=P_{LM}(F), which is the probability of F computed from an N-gram LM of the source language. This is usually modeled by an N−1 order Markov model.

Forward phrase translation feature:

φ_{F2Eph}(E, F, X)=P_{TMph}(E|F)=Πₖp(\tilde{e}ₖ|\tilde{f}ₖ), where \tilde{e}ₖ and \tilde{f}ₖ are the k-th phrase in E and F, respectively, and p(\tilde{e}ₖ|\tilde{f}ₖ) is the probability of translating \tilde{f}ₖ to \tilde{e}ₖ. This is usually modeled by a multinomial model.

Forward word translation feature:

φ_{F2Ewd}(E, F, X)=P_{TMwd}(E|F)=ΠₖΠₘΣₙp(e_{k,m}|f_{k,n}), where e_{k,m} is the m-th word of the k-th target phrase \tilde{e}ₖ, f_{k,n} is the n-th word in the k-th source phrase \tilde{f}ₖ, and p(e_{k,m}|f_{k,n}) is the probability of translating word f_{k,n} to word e_{k,m}. (This is also referred to as the lexical weighting feature.) Note, this feature is derived from the probability distribution {p(e_{k,m}|f_{k,n})} which is modeled by a multinomial model.

Backward phrase translation feature:

φ_{E2Fph}(E, F, X)=P_{TMph}(F|E)=Πₖp(\tilde{f}ₖ|\tilde{e}ₖ), where \tilde{e}ₖ and \tilde{f}ₖ are defined as and above.

Backward word translation feature:

φ_{E2Fwd}(E, F, X)=P_{TMwd}(F|E)=ΠₖΠₙΣₘp(f_{k,n}|e_{k,m}), where e_{k,m} and f_{k,n} are defined as above.

Translation reordering feature:

φ_{order}(E, F, X)=Pₕᵣ(S|E, F) is the probability of particular phrase segmentation and reordering S, given the source and target sentence E and F. In a phrase-based translation system, this is usually described by a heuristic function.

Target language model (LM) feature:

φ_{TLM}(E, F, X)=P_{LM} (E), which is the probability of E computed from an N-gram LM of the target language, modeled by an N−1 order Markov model.

Count of NULL translations:

φ_{NC}(E, F, X)=e^{|Null(F)|} is the exponential of the number of the source words that are not translated (i.e., translated to NULL word in the target side).

Count of phrases:

φ_{PC}(E, F, X)=e^{|{(\tilde{e}}^{ₖ}^{,\tilde{f}}^{ₖ}^{),k=1, . . . , K}|} is the exponential of the number of phrase pairs.

Translation length:

φ_{TWC}(E, F, X)=e^{|E|} is the exponential of the word count in translation E.

ASR (automatic speech recognition) hypothesis length:

φ_{SWC}(E, F, X)=e^{|F|} is the exponential of the word count in the source sentence F. (This is also referred to as word insertion penalty.)

An exemplary application of the growth transformation technique on the phrase translation model (using the backward phrase translation model), is now described.

P(F|E)=Πₖp(\tilde{f}ₖ|\tilde{e}ₖ)

it follows that,

$$p ( \tilde{f} \vert \tilde{e} , Λ ) = \frac{p ( \tilde{f} \vert \tilde{e} , {Λ}^{′} ) \frac{\partial F ( Λ ; {Λ}^{′} )}{\partial p ( \tilde{f} \vert \tilde{e} , Λ )} {\vert}_{Λ = {Λ}^{′}} + {D}_{\tilde{e}} \cdot p ( \tilde{f} \vert \tilde{e} , {Λ}^{′} )}{{\sum }_{\tilde{f}}^{ } p ( \tilde{f} \vert \tilde{e} , {Λ}^{′} ) \frac{\partial F ( Λ ; {Λ}^{′} )}{\partial p ( \tilde{f} \vert \tilde{e} , Λ )} {\vert}_{Λ = {Λ}^{′}} + {D}_{\tilde{e}}}$$

With respect to growth transformation for the phrase translation model, denoting Δ_{E}=[C(E)−O(Λ′)], it follows that:

$$p ( \tilde{f} \vert \tilde{e} , Λ ) = \frac{{\sum }_{k}^{ } {\sum }_{{E , F :}_{{{e}_{k} = \tilde{e}}_{{f}_{k} = \tilde{f}}}} p ( F , E \vert X , {Λ}^{′} ) {Δ}_{E} + {D}_{\tilde{e}} \cdot p ( \tilde{f} \vert \tilde{e} , {Λ}^{′} )}{{\sum }_{k}^{ } {\sum }_{{E , F :}_{{e}_{k} = \tilde{e}}} p ( F , E \vert X , {Λ}^{′} ) {Δ}_{E} + {D}_{\tilde{e}}}$$

where D_{\tilde{e}} is a constant independent from Λ. It could be proved that there exists a large enough D_{\tilde{e}} such that the above transformation can guarantee a growth of the value of objective function defined above. The forward phrase translation model has a similar growth transformation estimation formula.

With respect to the word translation model, the backward lexical weighting feature can be used to illustrate growth transformation. Given,

P(F|E,Λ)=ΠₖΠₘΣₙp(f_{k,m}|e_{k,m},Λ)

The growth translation formula for the word translation model p(g|h,Λ) is as follows:

$$p ( g \vert h , Λ ) = \frac{p ( g \vert h , {Λ}^{′} ) \frac{\partial F ( Λ ; {Λ}^{′} )}{\partial p ( g \vert h , Λ )} {\vert}_{Λ = {Λ}^{′}} + {D}_{h}}{{\sum }_{g}^{ } p ( g \vert h , {Λ}^{′} ) \frac{\partial F ( Λ ; {Λ}^{′} )}{\partial p ( g \vert h , Λ )} {\vert}_{Λ = {Λ}^{′}} + {D}_{h}}$$

This can be simplified to,

$$p ( g \vert h , Λ ) = \frac{{\sum }_{{k , m :}_{{f}_{k , m} = g}} {\sum }_{E , F}^{ } p ( E , F \vert X , {Λ}^{′} ) {Δ}_{E} {γ}_{h} ( k , m ) + {D}_{h} \cdot {p ( g \vert h , Λ )}^{′}}{{\sum }_{k , m}^{ } {\sum }_{E , F}^{ } p ( E , F \vert X , {Λ}^{′} ) {Δ}_{E} {γ}_{h} ( k , m ) + {D}_{h}}$$

where,

$${γ}_{h} ( k , m ) = \frac{{\sum }_{n : {e}_{k , n} = h}^{ } p ( {f}_{k , m} \vert {e}_{k , n} , {Λ}^{′} )}{{\sum }_{n}^{ } p ( {f}_{k , m} \vert {e}_{k , n} , {Λ}^{′} )}$$

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

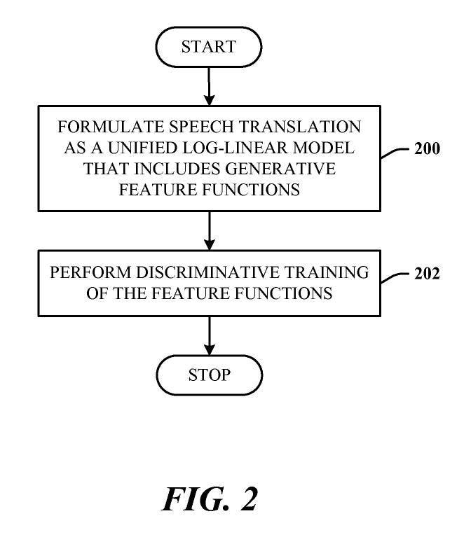

FIG. 2 illustrates a method in accordance with the disclosed architecture. At 200, speech translation is formulated as a unified log-linear model that includes generative feature functions. At 202, discriminative training of the feature functions is performed.

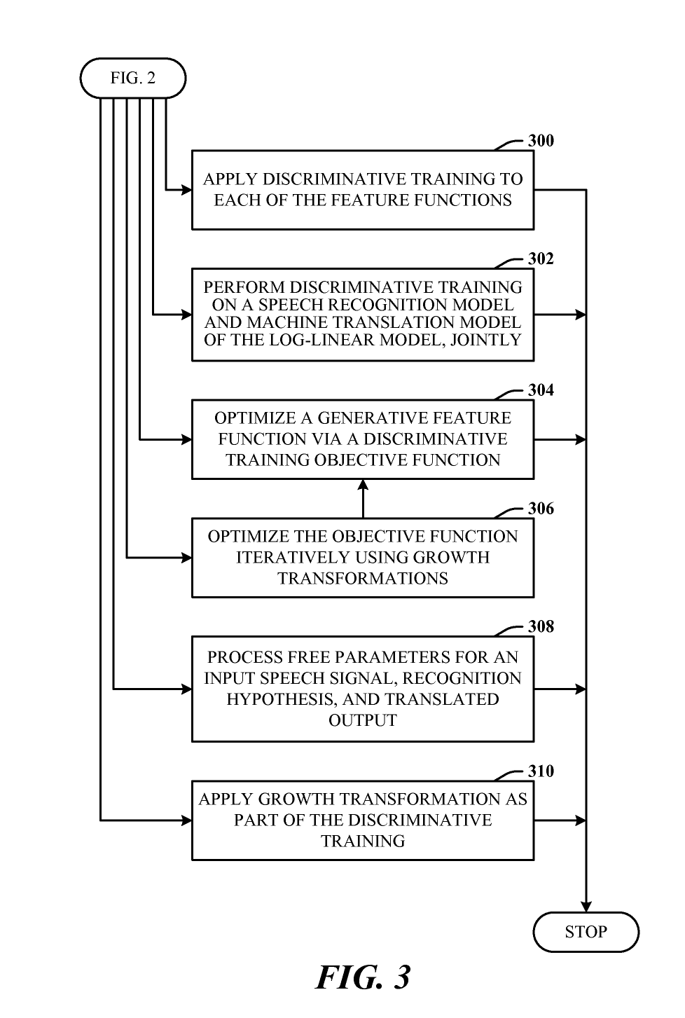

FIG. 3 illustrates further aspects of the method of FIG. 2. Note that the flow indicates that each block can represent a step that can be included, separately or in combination with other blocks, as additional aspects of the method represented by the flow chart of FIG. 2. At 300, discriminative training is applied to each of the feature functions. At 302, discriminative training is performed on a speech recognition model and machine translation model of the log-linear model, jointly. At 304, a generative feature function is optimized via a discriminative training objective function. At 306, the objective function is optimized iteratively using growth transformations. At 308, free parameters for an input speech signal, recognition hypothesis, and translated output are processed. At 310, growth transformation is applied as part of the discriminative training.

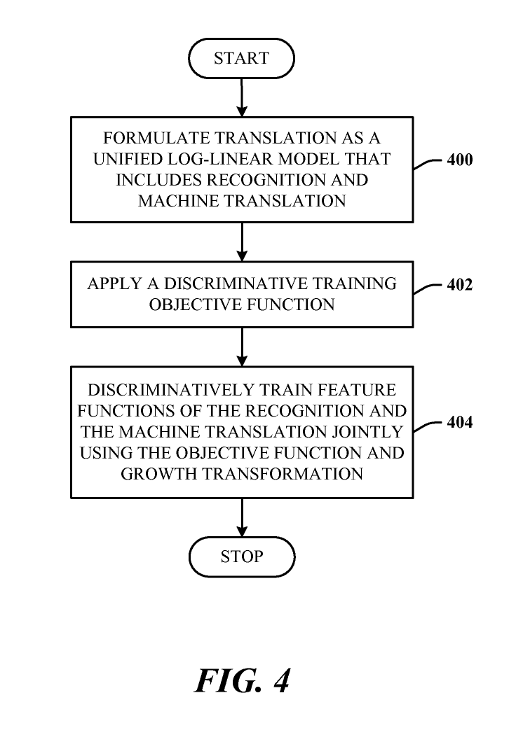

FIG. 4 illustrates an alternative method in accordance with the disclosed architecture. At 400, translation is formulated as a unified log-linear model that includes recognition and machine translation. At 402, a discriminative training objective function is applied. At 404, feature functions of the recognition and the machine translation are discriminatively trained jointly using the objective function and growth transformation.

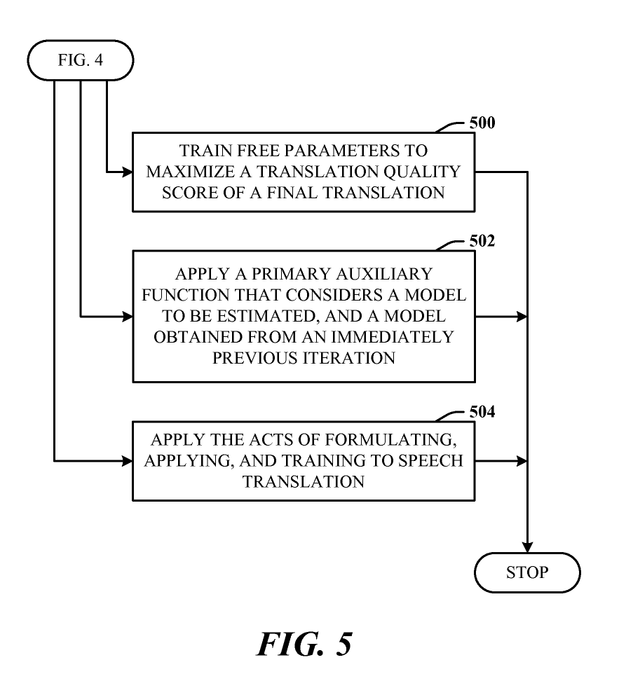

FIG. 5 illustrates further aspects of the method of FIG. 4. Note that the flow indicates that each block can represent a step that can be included, separately or in combination with other blocks, as additional aspects of the method represented by the flow chart of FIG. 4. At 500, free parameters are trained to maximize a translation quality score of a final translation. At 502, a primary auxiliary function is applied that considers a model to be estimated, and a model obtained from an immediately previous iteration. At 504, the acts of formulating, applying, and training are applied to speech translation.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

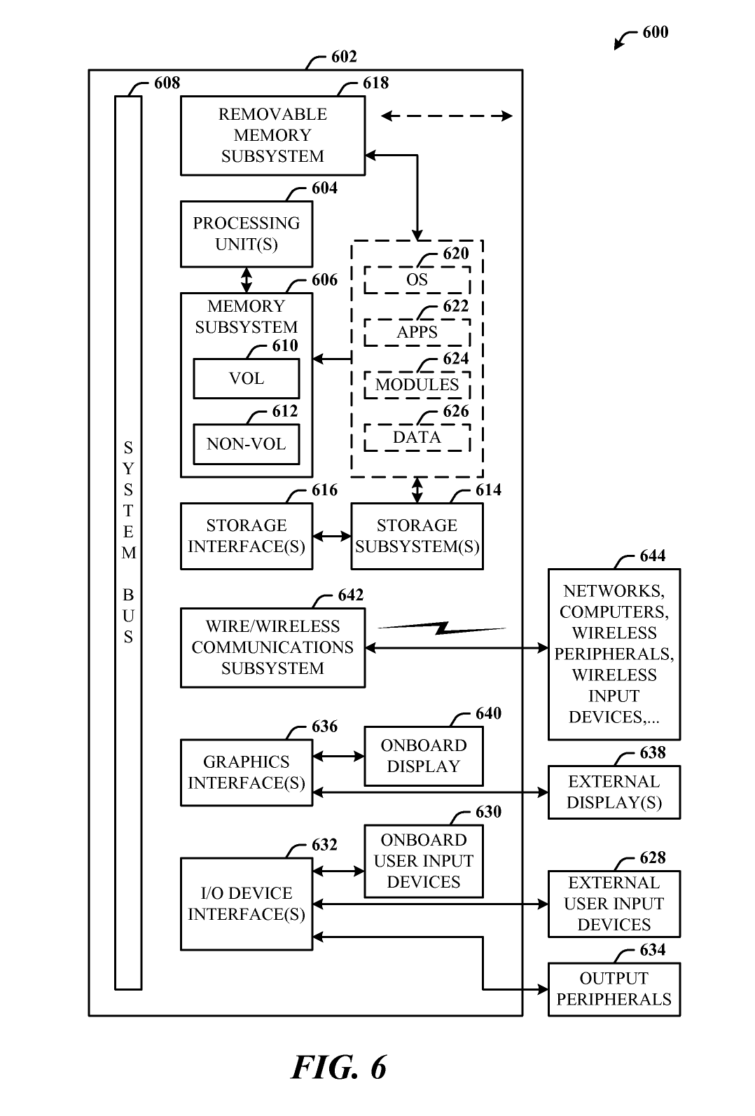

Referring now to FIG. 6, there is illustrated a block diagram of a computing system 600 that executes translation according to a unified translation system in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. In order to provide additional context for various aspects thereof, FIG. 6 and the following description are intended to provide a brief, general description of the suitable computing system 600 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 600 for implementing various aspects includes the computer 602 having processing unit(s) 604, a computer-readable storage such as a system memory 606, and a system bus 608. The processing unit(s) 604 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 606 can include computer-readable storage (physical storage media) such as a volatile (VOL) memory 610 (e.g., random access memory (RAM)) and non-volatile memory (NON-VOL) 612 (e.g., ROM, EPROM, EEPROM, etc.). A basic input/output system (BIOS) can be stored in the non-volatile memory 612, and includes the basic routines that facilitate the communication of data and signals between components within the computer 602, such as during startup. The volatile memory 610 can also include a high-speed RAM such as static RAM for caching data.

The system bus 608 provides an interface for system components including, but not limited to, the system memory 606 to the processing unit(s) 604. The system bus 608 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 602 further includes machine readable storage subsystem(s) 614 and storage interface(s) 616 for interfacing the storage subsystem(s) 614 to the system bus 608 and other desired computer components. The storage subsystem(s) 614 (physical storage media) can include one or more of a hard disk drive (HDD), a magnetic floppy disk drive (FDD), and/or optical disk storage drive (e.g., a CD-ROM drive DVD drive), for example. The storage interface(s) 616 can include interface technologies such as EIDE, ATA, SATA, and IEEE 1394, for example.

One or more programs and data can be stored in the memory subsystem 606, a machine readable and removable memory subsystem 618 (e.g., flash drive form factor technology), and/or the storage subsystem(s) 614 (e.g., optical, magnetic, solid state), including an operating system 620, one or more application programs 622, other program modules 624, and program data 626.

The operating system 620, one or more application programs 622, other program modules 624, and/or program data 626 can include the entities and components of the system 100 of FIG. 1, and the methods represented by the flowcharts of FIGS. 2-5, for example.

Generally, programs include routines, methods, data structures, other software components, etc., that perform particular tasks or implement particular abstract data types. All or portions of the operating system 620, applications 622, modules 624, and/or data 626 can also be cached in memory such as the volatile memory 610, for example. It is to be appreciated that the disclosed architecture can be implemented with various commercially available operating systems or combinations of operating systems (e.g., as virtual machines).

The storage subsystem(s) 614 and memory subsystems (606 and 618) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 602 and includes volatile and non-volatile internal and/or external media that is removable or non-removable. For the computer 602, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 602, programs, and data using external user input devices 628 such as a keyboard and a mouse. Other external user input devices 628 can include a microphone, an IR (infrared) remote control, a joystick, a game pad, camera recognition systems, a stylus pen, touch screen, gesture systems (e.g., eye movement, head movement, etc.), and/or the like. The user can interact with the computer 602, programs, and data using onboard user input devices 630 such a touchpad, microphone, keyboard, etc., where the computer 602 is a portable computer, for example. These and other input devices are connected to the processing unit(s) 604 through input/output (I/O) device interface(s) 632 via the system bus 608, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 632 also facilitate the use of output peripherals 634 such as printers, audio devices, camera devices, and so on, such as a sound card and/or onboard audio processing capability.

One or more graphics interface(s) 636 (also commonly referred to as a graphics processing unit (GPU)) provide graphics and video signals between the computer 602 and external display(s) 638 (e.g., LCD, plasma) and/or onboard displays 640 (e.g., for portable computer). The graphics interface(s) 636 can also be manufactured as part of the computer system board.

The computer 602 can operate in a networked environment (e.g., IP-based) using logical connections via a wired/wireless communications subsystem 642 to one or more networks and/or other computers. The other computers can include workstations, servers, routers, personal computers, microprocessor-based entertainment appliances, peer devices or other common network nodes, and typically include many or all of the elements described relative to the computer 602. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 602 connects to the network via a wired/wireless communication subsystem 642 (e.g., a network interface adapter, onboard transceiver subsystem, etc.) to communicate with wired/wireless networks, wired/wireless printers, wired/wireless input devices 644, and so on. The computer 602 can include a modem or other means for establishing communications over the network. In a networked environment, programs and data relative to the computer 602 can be stored in the remote memory/storage device, as is associated with a distributed system. It will be appreciated that the network connections shown are exemplary and other means of establishing a communications link between the computers can be used.

The computer 602 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a learning component that performs discriminative training of generative feature functions in a speech translation system using a growth transformation technique to fix free parameters in entirety of the speech translation system based on training data; and
a processor that executes computer-executable instructions associated with the learning component.

2. The system of claim 1, wherein the learning component includes an objective function that considers at least one of minimum sentence translation error rate, minimum translation edit rate, maximum average sentence BLEU (bi-lingual evaluation understudy) score, maximum corpus BLEU score, or maximum conditional likelihood.

3. The system of claim 1, wherein the discriminative training is performed across multiple machine translators.

4. The system of claim 1, wherein the learning component performs discriminative training on recognition model parameters and translation model parameters jointly in a unified log-linear speech translation model of both recognition and translation.

5. The system of claim 1, wherein the learning component employs a discriminative training objective function and optimizes the multiple generative feature functions as part of the training.

6. The system of claim 5, wherein the objective function for the unified log-linear model considers an input speech signal, a recognition hypothesis, and a translated output.

7. The system of claim 5, wherein the learning component trains feature weights to maximize a translation quality score of a final translation of a validation input set.

8. The system of claim 5, wherein the objective function is a model-based expectation of a classification quality measure.

9. The system of claim 1, wherein the growth transformation technique employs a primary auxiliary function that considers a model to be estimated, and a model obtained from an immediately previous iteration.

10. A computer-implemented method, comprising acts of:
formulating speech translation as a unified log-linear model that includes generative feature functions;
performing discriminative training of the feature functions; and
utilizing a processor that executes instructions stored in memory to perform at least one of the acts of formulating or performing.

11. The method of claim 10, further comprising applying discriminative training to each of the feature functions.

12. The method of claim 10, further comprising performing discriminative training on a speech recognition model and machine translation model of the log-linear model, jointly.

13. The method of claim 10, further comprising optimizing a generative feature function via a discriminative training objective function.

14. The method of claim 13, further comprising optimizing the objective function iteratively using growth transformations.

15. The method of claim 10, further comprising processing free parameters for an input speech signal, recognition hypothesis, and translated output.

16. The method of claim 10, further comprising applying growth transformation as part of the discriminative training.

17. A computer-implemented method, comprising acts of:
formulating translation as a unified log-linear model that includes recognition and machine translation;
applying a discriminative training objective function;
discriminatively training feature functions of the recognition and the machine translation jointly using the objective function and growth transformation; and
utilizing a processor that executes instructions stored in memory to perform at least one of the acts of formulating, applying, or training.

18. The method of claim 17, further comprising training free parameters to maximize a translation quality score of a final translation.

19. The method of claim 17, further comprising applying a primary auxiliary function that considers a model to be estimated, and a model obtained from an immediately previous iteration.

20. The method of claim 17, further comprising applying the acts of formulating, applying, and training to speech translation.
